(19) United States
(12) Patent Application Publication
(10) Pub. No.: US 2025/0291032 A1
(43) Pub. Date: Sep. 18, 2025

(54) RADAR DEVICE

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventors: Yufeng FU, Nisshin-shi (JP); Shinji YAMAURA, Nisshin-shi (JP)

(21) Appl. No.: 18/974,059

(22) Filed: Dec. 9, 2024

(30) Foreign Application Priority Data
Mar. 13, 2024 (JP) 2024-038530

(51) Int. Cl. G01S 7/41; G01S 13/02; G01S 13/931

(52) U.S. Cl. CPC G01S 7/41; G01S 13/931; G01S 2013/0245

(57) ABSTRACT

A radar device includes a transmission antenna, array antennas, and an angle estimating unit. The transmission antenna transmits an electromagnetic wave. Each of the array antennas includes antenna elements arranged linearly at equal intervals and receives the electromagnetic wave reflected by a target. The angle estimating unit estimates an angle indicating a direction of arrival of the reflected wave using the signal received by the array antennas. Two of the array antennas form a first antenna set arranged with a first distance and two of the array antennas form a second antenna set arranged with a second distance. The first antenna set has a first estimation accuracy characteristic. The second antenna set has a second estimation accuracy characteristic. The angle estimating unit estimates the angle using a first estimation result based on the first antenna set and a second estimation result based on the second antenna set.

### CROSS REFERENCE TO RELATED APPLICATION

The present application claims the benefit of priority from Japanese Patent Application No. 2024-038530 filed on Mar. 13, 2024. The entire disclosure of the above application is incorporated herein by reference.

### TECHNICAL FIELD

The present disclosure relates to a radar device.

### BACKGROUND

There is known a technique for estimating an angle indicating the direction of arrival of a reflected wave that is reflected by a target using signals of the reflected wave received by two array antennas.

### SUMMARY

According to one aspect of the present disclosure, a radar device is provided. The radar device includes a transmission antenna, array antennas, and an angle estimating unit. The transmission antenna transmits an electromagnetic wave as a transmitted wave. Each of the array antennas includes antenna elements disposed linearly in a predetermined arrangement direction at equal intervals. The array antennas are arranged in the predetermined arrangement direction and receive, as a received signal, a reflected wave that is the electromagnetic wave reflected by a target. The angle estimating unit estimates an angle indicating a direction of arrival of the reflected wave using the received signal received by each of the array antennas. Two of the array antennas are arranged with a first distance therebetween to form a first antenna set, and two of the array antennas are arranged with a second distance therebetween to form a second antenna set. The first antenna set has a first estimation accuracy characteristic for estimating the angle. The second antenna set has a second estimation accuracy characteristic that is different from the first estimation accuracy characteristic. The angle estimating unit is configured to estimate the angle using a first estimation result based on the received signal received by the first antenna set and a second estimation result based on the received signal received by the second antenna set.

### BRIEF DESCRIPTION OF THE DRAWINGS

FIG. 1 is a diagram showing the positional relationship between a host vehicle equipped with a radar device and another vehicle.

FIG. 2 is a block diagram illustrating the schematic configuration of a radar device.

FIG. 3 is an explanatory diagram showing the schematic configuration of array antennas.

FIG. 4 is an explanatory diagram showing an estimation accuracy characteristic of a first estimation result.

FIG. 5 is an explanatory diagram showing an estimation accuracy characteristic of a second estimation result. FIG. 6 is a flowchart showing a procedure of an angle estimation process.

### DETAILED DESCRIPTION OF THE PREFERRED EMBODIMENTS

To begin with, examples of relevant techniques will be described.

There is known a technique for estimating an angle indicating the direction of arrival of a reflected wave that is reflected by a target using signals of the reflected wave received by two array antennas.

The inventors have found that the angle estimation using two array antennas may suffer from reduced accuracy at certain angles.

The present disclosure may be provided by the following embodiments.

According to one aspect of the present disclosure, a radar device is provided. The radar device includes a transmission antenna, array antennas, and an angle estimating unit. The transmission antenna transmits an electromagnetic wave as a transmitted wave. Each of the array antennas includes antenna elements disposed linearly in a predetermined arrangement direction at equal intervals. The array antennas are arranged in the predetermined arrangement direction and receive, as a received signal, a reflected wave that is the electromagnetic wave reflected by a target. The angle estimating unit estimates an angle indicating a direction of arrival of the reflected wave using the received signal received by each of the array antennas. Two of the array antennas are arranged with a first distance therebetween to form a first antenna set, and two of the array antennas are arranged with a second distance therebetween to form a second antenna set. The first antenna set has a first estimation accuracy characteristic for estimating the angle. The second antenna set has a second estimation accuracy characteristic that is different from the first estimation accuracy characteristic.

The angle estimating unit is configured to estimate the angle using a first estimation result based on the received signal received by the first antenna set and a second estimation result based on the received signal received by the second antenna set.

According to this radar device, the multiple array antennas include the first antenna set arranged to have the first estimation accuracy characteristic and the second antenna set arranged to have the second estimation accuracy characteristic different from the first estimation accuracy characteristic. The angle estimating unit estimates the angle utilizing the first estimation result and the second estimation result. Thus, by selectively using the first estimation result and the second estimation result, which have different estimation accuracy characteristics, it is possible to suppress a decrease in the accuracy in the angle estimation.

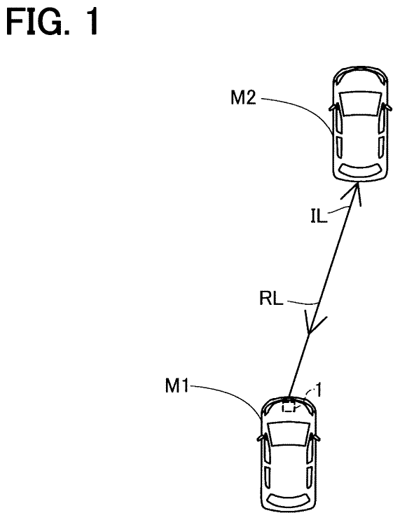

A. Embodiment: A-1. Device configuration: As shown in FIG. 1, a radar device 1 according to the embodiment is mounted on a host vehicle M1. The radar device 1 is installed, for example, in the front grill of the host vehicle M1. The radar device 1 detects a target present ahead of the host vehicle M1. In this embodiment, the target is another vehicle M2. More specifically, the radar device 1 radiates electromagnetic waves as transmitted waves IL. The transmitted wave IL is reflected by the target outside the host vehicle M1 and reflected as a reflected wave RL. The radar device 1 detects the direction in which the target exists relative to the host vehicle M1, based on the angle indicating a direction of arrival of the reflected wave RL. The radar device 1 may detect targets present in any direction around the host vehicle M1, not limited to the forward direction of the host vehicle M1.

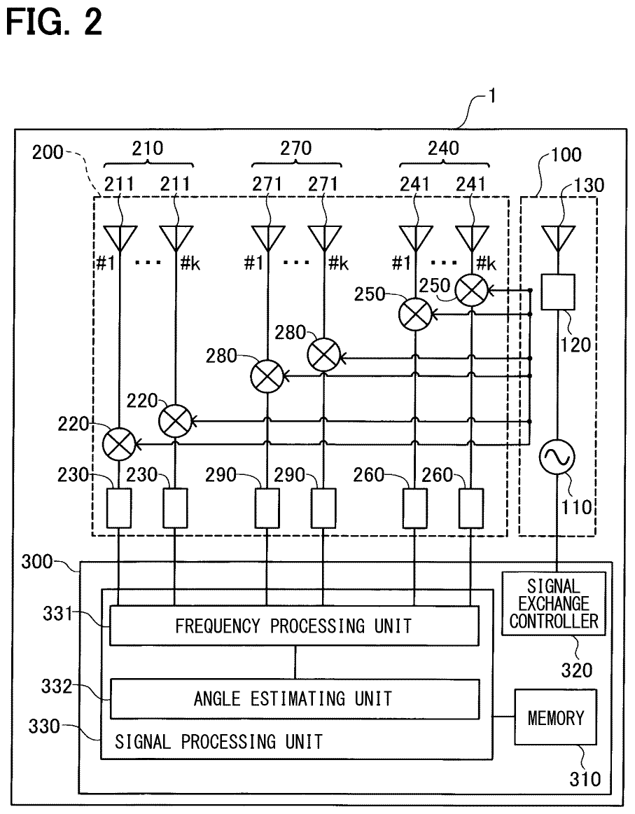

As shown in FIG. 2, the radar device 1 includes a transmitting unit 100, a receiving unit 200, and a processing unit 300. The radar device 1 is a millimeter wave radar. In this embodiment, the radar device 1 is a frequency modulated continuous wave (FMCW) radar.

The transmitting unit 100 includes an oscillator 110, a distributor 120, and a transmission antenna 130. The oscillator 110 is, for example, a voltage-controlled oscillator (VCO). When the oscillator 110 receives a triangular wave voltage signal from a signal exchange controller 320 of the processing unit 300, the oscillator 110 outputs a frequency-modulated high-frequency signal as a transmission signal. The transmission signal output by the oscillator 110 includes an upward section in which the frequency increases over time, and a downward section in which the frequency decreases over time.

The distributor 120 distributes the transmission signal supplied from the oscillator 110 to the transmission antenna 130 and first mixers 220, second mixers 250, and third mixers 280 of the receiving unit 200. The transmission antenna 130 radiates the transmission signal supplied from the oscillator 110 via the distributor 120 as an electromagnetic wave outward the host vehicle M1.

The receiving unit 200 includes a first array antenna 210, the first mixers 220, first A/D (Analog to Digital) converters 230, a second array antenna 240, the second mixers 250, second A/D converters 260, a third array antenna 270, the third mixers 280, and third A/D converters 290. In this manner, the radar device 1 of this embodiment includes multiple array antennas.

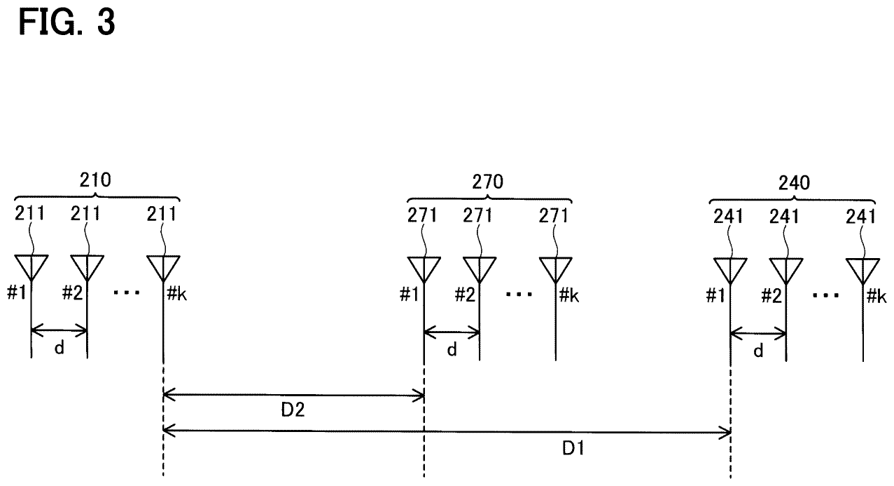

As shown in FIG. 3, the first array antenna 210 is an equally spaced linear array antenna having antenna elements 211 arranged with a distance d therebetween at equal intervals. The number of the antenna elements 211 is K, and the K antenna elements 211 are arranged linearly in the predetermined arrangement direction. Where, K is an integer equal to or greater than 2. The K antenna elements 211 correspond to the first to Kth channels, respectively.

In this embodiment, the distance d is half the wavelength of the transmitted wave IL. The distance d does not have to be strictly the same as half the wavelength of the transmitted wave IL, but may be regarded as being the same as half the wavelength of the transmitted wave IL, taking into consideration design errors, variations, and the like.

The first array antenna 210 receives the reflected wave RL reflected by the target as a received signal, and outputs the received signal to the first mixers 220.

The first mixers 220 shown in FIG. 1 mix the transmission signals distributed by the distributor 120 with the received signals input from the antenna elements 211, and outputs beat signals. Since the radar device 1 uses a triangular wave as a carrier wave, the first mixer 220 generates and outputs beat signals in each of the upward and downward sections. The beat signals output by the first mixers 220 are supplied to the first A/D converters 230.

The first A/D converters 230 convert the beat signals into digital signals by sampling and quantizing the beat signals at a sampling frequency. The converted digital signals are supplied to the processing unit 300.

As shown in FIG. 3, the second array antenna 240, like the first array antenna 210, is an equally spaced linear array antenna having antenna elements 241 arranged with the distance d at equal intervals. The number of the array antennas is K, and the K array antennas are arranged linearly in a predetermined arrangement direction. Where, K is an integer equal to or greater than 2. The K antenna elements 241 correspond to the first to Kth channels, respectively.

The first array antenna 210 and the second array antenna 240 are arranged with a distance D1 therebetween in the arrangement direction of the antenna elements 211 and the antenna elements 241. More specifically, the first array antenna 210 and the second array antenna 240 are arranged so that the distance D1 is defined between the antenna element 211 that is closest to the second array antenna 240 among the multiple antenna elements 211 that constitute the first array antenna 210 and the antenna element 241 that is closest to the first array antenna 210 among the multiple antenna elements 241 that constitute the second array antenna 240. In this embodiment, the distance D1 is 400 times the half wavelength of the transmitted wave IL. In the present disclosure, the distance D1 corresponds to “a first distance”. In the following description, the set of the first array antenna 210 and the second array antenna 240 is also referred to as a “first antenna set.”

The second array antenna 240 receives the reflected wave RL reflected by the target as a received signal, and outputs the received signal to the second mixers 250.

The configuration of the second mixers 250 shown in FIG. 2 is like the configuration of the first mixers 220, and thus the description thereof will be omitted. Moreover, the configuration of the second A/D converters 260 is like the configuration of the first A/D converters 230, and thus the description thereof will be omitted.

As shown in FIG. 3, the third array antenna 270, like the first array antenna 210, is an equally spaced linear array antenna having antenna elements 271 arranged with the distance d therebetween at equal intervals. The number of the antenna elements 271 is K and the K antenna elements 271 are arranged linearly in the predetermined arrangement direction. Where, K is an integer equal to or greater than 2. The K antenna elements 271 correspond to the first to Kth channels, respectively.

The first array antenna 210 and the third array antenna 270 are arranged with a distance D2 therebetween in the arrangement direction of the antenna elements 211 and the antenna elements 271. More specifically, the first array antenna 210 and the third array antenna 270 are arranged so that the distance D2 is defined between the antenna element 211 that is closest to the third array antenna 270 among the multiple antenna elements 211 that constitute the first array antenna 210 and the antenna element 271 that is closest to the first array antenna 210 among the multiple antenna elements 271 that constitute the third array antenna 270. In this embodiment, the distance D2 is 300 times the half wavelength of the transmitted wave IL. In the present disclosure, the distance D2 corresponds to “a second direction”. In the following description, the set of the first array antenna 210 and the third array antenna 270 is also referred to as a “second antenna set.”

In this embodiment, the distance D2 is set so that the ratio of the distance D1 to the distance D2 falls within the range of “1.3+n to 1.5+n (n is an integer equal to or greater than 0).” As described above, in this embodiment, the distance D1 is 400 times the half wavelength of the transmitted wave IL, and the distance D2 is 300 times the half wavelength of the transmitted wave IL. That is, in this embodiment, the ratio of the distance D1 to the distance D2 is approximately “1.33”, which is within the range of “1.3 to 1.5”. By setting the distance D2 in this manner, the estimation accuracy characteristics of the first estimation result, which will be described later, can be appropriately differentiated from the estimation accuracy characteristics of the second estimation result. By using the first estimation result and the second estimation result, estimation accuracy can be prevented from deteriorating. In this embodiment, by conducting experiments and simulations in advance, it has been found that when the ratio of the distance D1 to the distance D2 falls within the range of “1.3+n to 1.5+n (n is an integer greater than or equal to 0),” the estimation accuracy characteristics of the first estimation result and the estimation accuracy characteristics of the second estimation result can be appropriately differentiated.

The third array antenna 270 receives the reflected wave RL reflected by the target as a received signal, and outputs the received signal to the third mixers 280.

The configuration of the third mixers 280 shown in FIG. 2 is like the configuration of the first mixers 220, and thus the description thereof will be omitted. Moreover, the configuration of the third A/D converters 290 is like the configuration of the first A/D converters 230, and thus the description thereof will be omitted.

The processing unit 300 includes a memory 310, a signal exchange controller 320, and a signal processing unit 330. The processing unit 300 is configured by a computer including a CPU (Central Processing Unit), a memory, and the like. The memory 310 stores various programs and data executed in the radar device 1. The signal exchange controller 320 controls the transmitting unit 100 and the receiving unit 200.

The signal processing unit 330 periodically executes a series of signal processing steps. The signal processing unit 330 functions as a frequency processing unit 331 and an angle estimating unit 332. The frequency processing unit 331 performs frequency conversion on each of the digital signals input from the first A/D converters 230, the second A/D converters 260, and the third A/D converters 290, for example, by FFT (Fast Fourier Transform), and calculates a beat frequency. The frequency processing unit 331 outputs the calculated beat frequency to the angle estimating unit 332.

The angle estimating unit 332 estimates the angle indicating the direction of arrival of the reflected wave RL based on the beat frequency. In this embodiment, the angle estimating unit 332 estimates the angle indicating the direction of arrival of the reflected wave RL using ESPRIT (Estimation of Signal Parameter via Rotational Invariance Technique) as a calculation algorithm. In this embodiment, the angle estimating unit 332 executes a first estimation process using a beat frequency based on a signal received by the first antenna set, and a second estimation process using a beat frequency based on a signal received by the second antenna set.

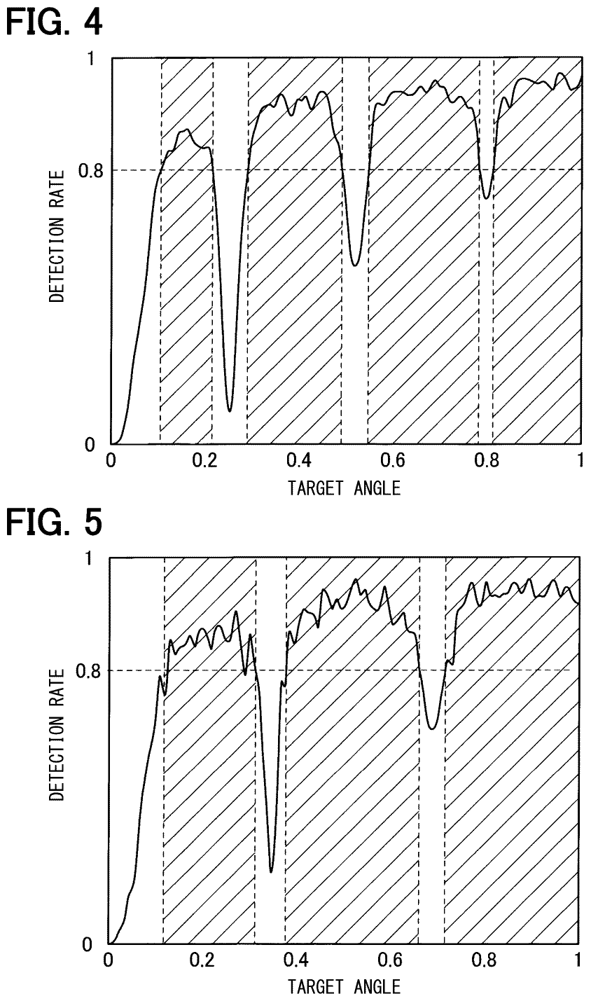

The estimation accuracy characteristic of the first estimation process will be described with reference to FIG. 4. In the following description, the estimation accuracy characteristic of the first estimation process is also referred to as a “first estimation accuracy characteristic.” In FIG. 4, the vertical axis indicates the detection rate, and the horizontal axis indicates the target angle. FIG. 4 shows the estimation accuracy characteristics when the target angle is in the range of 0° to 1°. The “target angle” refers to, in detection for two targets, the angle between the direction of arrival of the reflected wave RL that is reflected by a first target and the direction of arrival of the reflected wave RL that is reflected by a second target. The “detection rate” refers to the ratio of the number of times angle estimation is correctly performed to the predetermined number of angle estimation trials for each target angle. In this embodiment, when the angle estimation result falls within a range centered on the target angle, which is regarded as the same size as the target angle, it is determined that the angle estimation has been correctly performed. For example, in angle estimation for the target angle of 0.4°, when the angle estimation result falls within an angle range of 0.4°±0.2°, it is determined that the angle estimation has been correctly performed.

In FIG. 4, the angle range of the target angle where the detection rate is 0.8 or more is shown by hatching. As shown in FIG. 4, the angle range in which the detection rate is 0.8 or more and the angle range in which the detection rate is less than 0.8 alternate in the angle range of the target angle from 0° to 1°. The inventors have found that the angle range in which the detection rate is 0.8 or more and the angle range in which the detection rate is less than 0.8 vary depending on the beam pattern of each array antenna and the positional relationship between the two array antennas. In the first estimation accuracy characteristic of this embodiment, the detection rate is less than 0.8 in the angle ranges of 0.1° or less, 0.2° to 0.3°, around 0.5°, and around 0.8°.

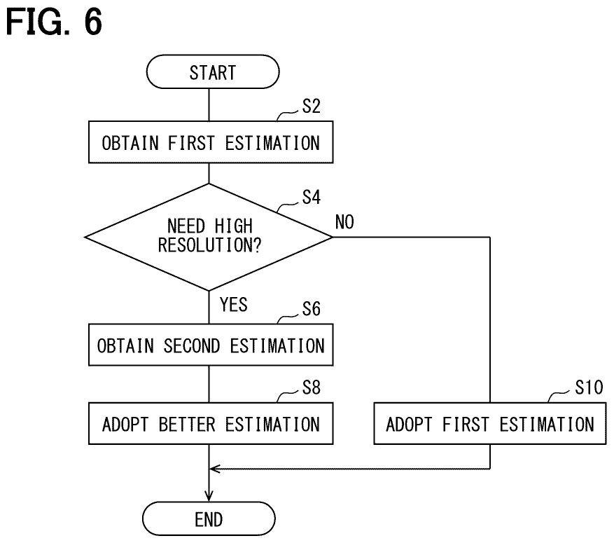

Next, the estimation accuracy characteristic of the second estimation process will be described with reference to FIG. 5. In the following description, the estimation accuracy characteristic of the second estimation process is also referred to as a “second estimation accuracy characteristic.” In FIG. 5, the vertical axis indicates the detection rate, and the horizontal axis indicates the target angle. FIG. 5 shows the estimation accuracy characteristics when the target angle is in the angle range of 0° to 1°, similarly to FIG. 4. In FIG. 5, the angle range of the target angle where the detection rate is 0.8 or more is indicated by hatching. As shown in FIG. 5, in the second estimation accuracy characteristic, the detection rate is less than 0.8 in the angle ranges of 0.1° or less, 0.3° to 0.4°, and around 0.7°. In this way, the angle range in which the detection rate is less than 0.8 in the first estimation process and the angle range in which the detection rate is less than 0.8 in the second estimation process are different from each other.

A-2. Angle Estimation Process: The angle estimating unit 332 executes the angle estimation process shown in FIG. 6 at a predetermined cycle. In step S2, the angle estimating unit 332 executes a first estimation process using the beat frequency calculated based on the signals received by the first radar set, and obtains the first estimation result for the target angle.

In step S4, the angle estimating unit 332 determines whether high resolution is required. In this embodiment, the angle estimating unit 332 determines that high resolution is required when the first estimation result is less than 1°.

If it is determined that high resolution is required (step S4: Yes), in step S6, the angle estimating unit 332 performs the second estimation process using the beat frequency calculated based on the received signals received by the second radar set, and obtains the second estimation result for the target angle.

In step S8, the angle estimating unit 332 selects one of the first and second estimation results that is more appropriate depending on the estimation accuracy characteristics of the first and second estimation processes. For example, when the first estimation result is 0.5°, which is included in the angle range in which the detection rate is low in the first estimation accuracy characteristic, the angle estimating unit 332 adopts the second estimation result. That is, generally, the first and second estimation processes have different angle ranges where the detection rate is less than 0.8, and the angle estimating unit 332 estimates the angle indicating the direction of arrival of the reflected wave RL by referring to one of the first and second estimation results having the detection rate of 0.8 or more. In this manner, angle is estimated by selectively referring to one of the first estimation result and the second estimation result in this embodiment. Thus, an appropriate estimation result can be adopted depending on the estimation accuracy characteristics, and a decrease in the estimation accuracy of the arrival direction can be suppressed. In addition, when the detection rate for the target angle is 0.8 or higher in both the first estimation result and the second estimation result, the angle estimating unit 332 may perform angle estimation by referring to one of the predetermined estimation results.

If it is determined in step S4 that high resolution is not required (step S4: No), the angle estimating unit 332 adopts the first estimation result and ends the angle estimation process. When high resolution is not required, the first estimation result is adopted. Thus, there is no need to perform additional angle estimation based on the received signal received by the second radar set. This prevents the extension of the time required for the angle estimation.

The radar device 1 of the embodiment described above includes the first antenna set arranged to have the first estimation accuracy characteristic and the second antenna set arranged to have the second estimation accuracy characteristic different from the first estimation accuracy characteristic. The angle estimating unit 332 estimates the angle using the first estimation result and the second estimation result. Thus, by selectively using the first estimation result and the second estimation result, which have different estimation accuracy characteristics, it is possible to suppress a decrease in the accuracy in the angle estimation.

In addition, the angle is estimated by referring to one of the first estimation result and the second estimation result that has an angle estimation accuracy equal to or higher than a predetermined threshold value. Thus, an appropriate estimation result can be adopted depending on the estimation accuracy characteristics, and a decrease in the estimation accuracy of the direction of arrival can be further suppressed.

In addition, the distance D1 and the distance D2 are specified so that the ratio of the first distance to the second distance falls within the range of 1.3+n to 1.5+n (n is an integer greater than or equal to 0). This enables the first accuracy estimation characteristic and the second estimation accuracy characteristic to be appropriately differentiated. Thus, by using the first estimation result and the second estimation result appropriately, the deterioration of the estimation accuracy can be suppressed.

Furthermore, in angle estimation using ESPRIT, a decrease in estimation accuracy can be suppressed.

B. Other Embodiments: (B1) In the above embodiment, the radar device 1 includes three array antennas: the first array antenna 210, the second array antenna 240, and the third array antenna 270. However, the present disclosure is not limited to this. Furthermore, the first array antenna 210 is included in both the first radar set and the second radar set, but the present disclosure is not limited to this. For example, the radar device 1 may further include a fourth array antenna, and the set of the third array antenna 270 and the fourth array antenna may be used as the second radar set. This feature also provides the same effects as the above embodiment.

Furthermore, the radar device 1 includes two radar sets, the first radar set and the second radar set, but the present disclosure is not limited to this. The radar device 1 may include three or more radar sets having different estimation accuracy characteristics. This feature also provides the same effects as the above embodiment. In addition, since the options for the estimation accuracy characteristics are increased, the possibility that the estimation result will be included in an area with a low detection rate can be reduced, and a decrease in the estimation accuracy in the angle estimation can be further prevented.

(B2) In the above embodiment, the ratio of the distance D1 to the distance D2 falls within the range of “1.3+n to 1.5+n (n is an integer equal to or greater than 0).” However, the present disclosure is not limited to this. The relationship between the distance D1 and the distance D2 may be such that one of the distances D1 and D2 is not an integer multiple of the other of the distances D1 and D2. With this configuration, as in the above embodiment, the estimation accuracy characteristics of the first estimation result can be differentiated from the second estimation accuracy characteristics, and by using the first estimation result and the second estimation result appropriately, a decrease in the estimation accuracy can be suppressed.

(B3) In the above embodiment, the angle estimating unit 332 estimates the angle indicating the direction of arrival of the reflected wave RL using ESPRIT as a calculation algorithm, but the present disclosure is not limited to this. The angle estimating unit 332 may estimate the angle indicating the direction of arrival of the reflected wave RL by using another calculation algorithm such as MUSIC (Multiple Signal Classification). This feature also provides the same effects as the above embodiment.

(B4) In the above embodiment, the angle estimating unit 332 determines that high resolution is required when the first estimation result is equal to or less than 1° in step S4 of the angle estimation process, but the present disclosure is not limited to this. The angle estimating unit 332 may determine that high resolution is required, for example, when the distance to the target estimated using the beat frequency is equal to or greater than a predetermined threshold value. This feature also provides the same effects as the above embodiment. Furthermore, the angle estimating unit 332 may always perform angle estimation using both the first estimation result and the second estimation result, regardless of whether high resolution is required or not.

(B5) In the above embodiment, in step S4 of the angle estimation process, the angle estimating unit 332 estimates the angle indicating the direction of arrival of the reflected wave RL by referring to one of the first and second estimation results which has a detection rate of 0.8 or more, but the present disclosure is not limited to this. The angle estimating unit 332 may estimate the angle indicating the direction of arrival of the reflected wave RL by referring to an estimation result that is equal to or greater than a predetermined threshold value, which is not limited to 0.8. The threshold value may be set arbitrarily depending on the estimation accuracy required for the angle estimation. This feature also provides the same effects as the above embodiment.

(B6) In the above embodiment, the angle estimating unit 332 performs angle estimation by selectively referring to one of the first estimation result and the second estimation result, but the present disclosure is not limited to this. For example, if both the first and second estimation results have the detection rate for the target angle of 0.8 or higher, the angle estimating unit 332 may perform angle estimation using the average of the first estimation result and the second estimation result.

The processing unit 300 and the techniques thereof according to the present disclosure may be implemented by one or more special-purposed computers. Such a special-purposed computer may be provided by configuring a processor and a memory programmed to execute one or more functions embodied by a computer program. Alternatively, the processing unit 300 and the techniques thereof described in the present disclosure may be implemented by a dedicated computer provided by configuring a processor with one or more dedicated hardware logic circuits. Alternatively, the processing unit 300 and the techniques thereof described in the present disclosure may be implemented by one or more dedicated computers configured by a combination of a processor and a memory programmed to execute one or more functions and a processor configured by one or more hardware logic circuits. Furthermore, the computer program may be stored in a computer-readable non-transitory tangible storage medium as an instruction executed by a computer.

The present disclosure should not be limited to the embodiments described above, and various other embodiments may be implemented without departing from the scope of the present disclosure. For example, the technical features in each embodiment corresponding to the technical features in the form described in the summary may be replaced or combined to solve some or all the above-described problems, or to provide one of the above-described effects. Also, some of the technical features may be omitted as appropriate.

1. A radar device comprising:
a transmission antenna configured to transmit an electromagnetic wave as a transmitted wave;
a plurality of array antennas each of which includes a plurality of antenna elements arranged linearly in a predetermined arrangement direction at equal intervals, the plurality of array antennas being arranged in the predetermined arrangement direction and configured to receive, as a received signal, a reflected wave that is the electromagnetic wave reflected by a target; and
an angle estimating unit configured to estimate an angle indicating a direction of arrival of the reflected wave using the received signal received by each of the plurality of array antennas, wherein
two of the plurality of array antennas are arranged with a first distance therebetween to form a first antenna set,
two of the plurality of array antennas are arranged with a second distance therebetween to form a second antenna set,
the first antenna set has a first estimation accuracy characteristic for estimating the angle,
the second antenna set has a second estimation accuracy characteristic that is different from the first estimation accuracy characteristic, and
the angle estimating unit is configured to estimate the angle using a first estimation result based on the received signal received by the first antenna set and a second estimation result based on the received signal received by the second antenna set.

2. The radar device according to claim 1, wherein
the angle estimating unit is configured to estimate the angle by referring to one of the first estimation result and the second estimation result that has an estimation accuracy for the angle equal to or greater than a predetermined threshold.

3. The radar device according to claim 1, wherein
one of the first distance and the second distance is not an integer multiple of the other of the first distance and the second distance.

4. The radar device according to claim 3, wherein
a ratio of the first distance to the second distance falls within a range between 1.3+n and 1.5+n, and
n is an integer equal to or greater than zero.

5. The radar device according to claim 1, wherein
the angle estimating unit is configured to estimate the angle using ESPRIT.

6. The radar device according to claim 2, wherein
the angle estimating unit is configured to estimate the angle by referring to one of the first estimation result and the second estimation result based on the first estimation result falling within a range that requires high resolution.

7. The radar device according to claim 2, wherein
the angle estimating unit is configured to estimate the angle by averaging the first estimation result and the second estimation result based on both the first estimation result and the second estimation result having the estimation accuracy equal to or greater than the predetermined threshold.
